(19) United States
(12) Patent Application Publication
(10) Pub. No.: US 2016/0097954 A1
(43) Pub. Date: Apr. 7, 2016

(54) DISPLAY DEVICE AND MANUFACTURING METHOD THEREOF

(71) Applicant: SAMSUNG DISPLAY CO., LTD., Yongin-si (KR)

(72) Inventors: Yun-Gun LEE, Asan-si (KR); Min Wook PARK, Asan-si (KR)

(21) Appl. No.: 14/870,193

(22) Filed: Sep. 30, 2015

(30) Foreign Application Priority Data
Oct. 1, 2014 (KR) 10-2014-0132647
Feb. 25, 2015 (KR) 10-2015-0026689

(51) Int. Cl. G02F 1/1337; G02F 1/1341

(52) U.S. Cl. CPC G02F 1/133788; G02F 1/1341; G02F 1/133711; G02F 2001/133726

(57) ABSTRACT

A method for manufacturing a display device, including providing a first substrate and a second substrate; forming a display panel, forming the display panel including injecting a liquid crystal layer including liquid crystal molecules between the first substrate and the second substrate; bending the display panel to a predetermined curvature to form a bent display panel; and forming an alignment layer so that directions in which the liquid crystal molecules are arranged in the liquid crystal layer of the bent display panel include a plurality of different domains.

### CROSS-REFERENCE TO RELATED APPLICATION

Korean Patent Application No. 10-2014-0132647, filed on Oct. 1, 2014, in the Korean Intellectual Property Office, and entitled: “Display Device and Manufacturing Method Thereof,” and Korean Patent Application No. 10-2015-0026689, filed on Feb. 25, 2015, in the Korean Intellectual Property Office, are incorporated by reference herein in their entireties.

### BACKGROUND

1. Field

Provided are a display device and a manufacturing method thereof.

2. Description of the Related Art

A liquid crystal display, which is a flat panel display, may include two substrates with field generating electrodes such as a pixel electrode and a common electrode, and a liquid crystal layer interposed therebetween.

### SUMMARY

Embodiments may be realized by providing a method for manufacturing a display device, including providing a first substrate and a second substrate; forming a display panel, forming the display panel including injecting a liquid crystal layer including liquid crystal molecules between the first substrate and the second substrate; bending the display panel to a predetermined curvature to form a bent display panel; and forming an alignment layer so that directions in which the liquid crystal molecules are arranged in the liquid crystal layer of the bent display panel include a plurality of different domains.

Forming the alignment layer may include applying an electric field to the liquid crystal layer after bending the display panel; and irradiating beams or applying heat to the display panel.

The liquid crystal molecules of the liquid crystal layer may be substantially perpendicular to surfaces of the first substrate and the second substrate prior to bending the display panel.

Pretilt angles of the liquid crystal molecules near the first substrate and the liquid crystal molecules near the second substrate may be different from each other.

The pretilt angles of the liquid crystal molecules near the first substrate may be equal to or greater than 80 degrees and less than 89 degrees, and the pretilt angles of the liquid crystal molecules near the second substrate may be equal to or greater than 89 degrees and equal to or less than 90 degrees.

Forming the display panel may include: manufacturing a lower panel and an upper panel; applying a same alignment material including a reactive mesogen to the lower panel and the upper panel; curing the upper panel; exposing ultraviolet rays to the upper panel; and forming a liquid crystal layer and bonding the two panels.

Curing the upper panel may include: pre-curing the upper panel; and main-curing the upper panel, wherein the main-curing is performed for longer than 30 minutes.

The ultraviolet rays may have an intensity of about 5 J/cm² to 10 J/cm²; and exposing the ultraviolet rays to the upper panel may include exposing the ultraviolet rays for about 20 minutes to an hour.

Forming the display panel may include injecting the liquid crystal molecules and prepolymers polymerized by light between the first substrate and the second substrate.

Forming the alignment layer may include applying an electric field to the liquid crystal layer after bending the display panel; and irradiating light to the display panel.

The liquid crystal molecules of the liquid crystal layer may be substantially perpendicular to surfaces of the first substrate and the second substrate prior to bending the display panel.

Each of the plurality of different domains may include liquid crystal molecules arranged in a single direction.

Adjacent domains may have a domain boundary therebetween, the direction of arrangement of the liquid crystal molecules changing at the domain boundary.

Pretilt angles of the liquid crystal molecules near the first substrate and the liquid crystal molecules near the second substrate may be different from each other.

The pretilt angle of the liquid crystal molecules near the first substrate may be equal to or greater than 80 degrees and less than 89 degrees, and the pretilt angle of the liquid crystal molecules near the second substrate may be equal to or greater than 89 degrees and equal to or less than 90 degrees.

The liquid crystal layer may include a prepolymer cured by polymerization caused by ultraviolet rays and an ammonium-based material combined to the prepolymer, and the prepolymer and the ammonium-based material may have positive (+) polarity.

Applying the electric field to the liquid crystal layer may include moving the prepolymer and the ammonium-based material to the lower panel by the electric field.

Embodiments may be realized by providing a display device, including a first substrate and a second substrate facing each other; a liquid crystal layer between the first substrate and the second substrate and including liquid crystal molecules; and an alignment layer on surfaces of the first substrate and the second substrate, he display device being bent to a predetermined curvature and including a plurality of domains in which arranged directions of the liquid crystal molecules of the liquid crystal layer are different.

At least one of the alignment layer and the liquid crystal layer may include photopolymers.

The liquid crystal molecules of the liquid crystal layer may be substantially perpendicular to surfaces of the first substrate and the second substrate prior to the display device being bent.

The liquid crystal molecules of the liquid crystal layer may be substantially perpendicular to surfaces of the first substrate and the second substrate prior to the display device being bent.

Pretilt angles of the liquid crystal molecules near the first substrate and the liquid crystal molecules near the second substrate may be different from each other.

The pretilt angle of the liquid crystal molecules near the first substrate may be equal to or greater than 80 degrees and less than 89 degrees, and the pretilt angle of the liquid crystal molecules near the second substrate may be equal to or greater than 89 degrees and equal to or less than 90 degrees.

Each of the plurality of domains may include liquid crystal molecules arranged in a single direction.

Adjacent domains may have a domain boundary therebetween, the direction of arrangement of the liquid crystal molecules changing at the domain boundary.

### BRIEF DESCRIPTION OF THE DRAWINGS

Features will become apparent to those of skill in the art by describing in detail exemplary embodiments with reference to the attached drawings in which:

FIG. 1A to FIG. 1D illustrate a method for manufacturing a display device according to an exemplary embodiment;

FIG. 2 illustrates a method for manufacturing a display device according to an exemplary embodiment;

FIG. 3 illustrates a top plan view of a basic electrode of a display device according to an exemplary embodiment;

FIG. 4A to FIG. 4E illustrate a method for manufacturing a display device according to another exemplary embodiment;

FIG. 5A and FIG. 5B illustrate a comparative display device and a manufacturing method thereof;

FIG. 6 illustrates a flowchart of a method for manufacturing a display device according to a second exemplary embodiment;

FIG. 7 and FIG. 8 illustrate results of a comparative embodiment and a second exemplary embodiment for forming a pretilt angle on an upper panel through a curing process;

FIG. 9 and FIG. 10 illustrate results of a comparative embodiment and a second exemplary embodiment for forming a pretilt angle on an upper panel by irradiating ultraviolet ray; and

FIG. 11A through FIG. 11E illustrate a method for manufacturing a display device according to a third exemplary embodiment.

### DETAILED DESCRIPTION

Example embodiments will be described more fully hereinafter with reference to the accompanying drawings; however, they may be embodied in different forms and should not be construed as limited to the embodiments set forth herein. Rather, these embodiments are provided so that this disclosure will be thorough and complete

In the drawings, the dimensions, e.g., thickness, of layers, films, panels, regions, etc., may be exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present.

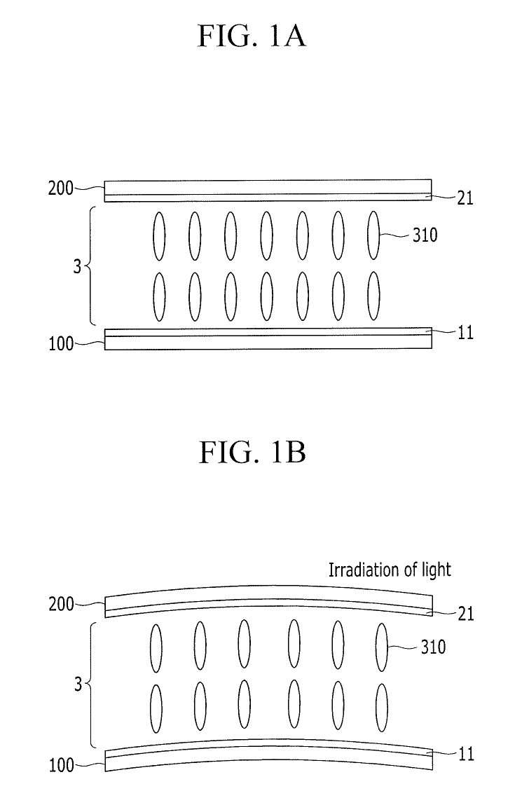

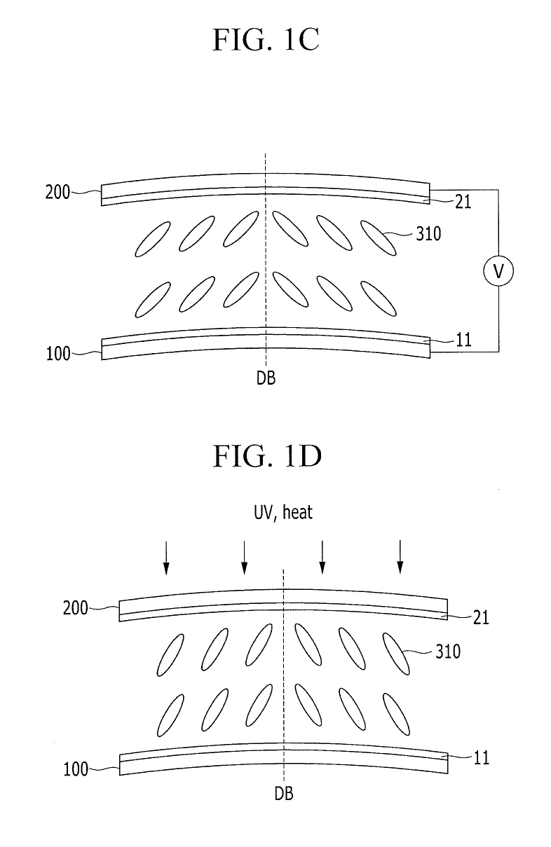

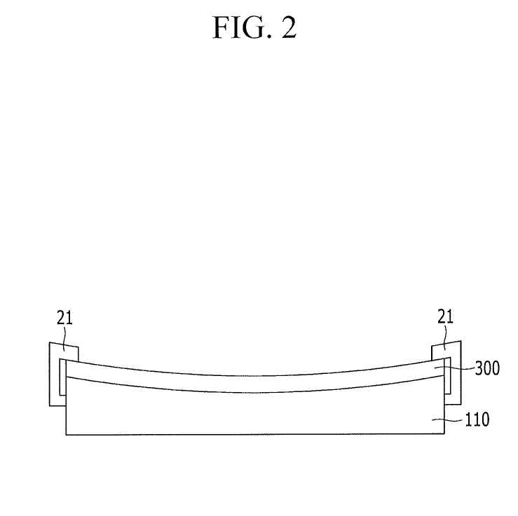

A method for manufacturing a display device according to an exemplary embodiment will now be described with reference to FIG. 1A to FIG. 1D and FIG. 2. FIG. 1A to FIG. 1D illustrate a method for manufacturing a display device according to an exemplary embodiment, and FIG. 2 illustrates a method for manufacturing a display device according to an exemplary embodiment.

Referring to FIG. 1A, a first alignment layer 11 and a second alignment layer 21 may be stacked on a first substrate 100 and a second substrate 200 facing each other, and a liquid crystal layer 3 including a plurality of liquid crystal molecules 310 may be injected between the first substrate 100 and the second substrate 200.

The first alignment layer 11 and the second alignment layer 21 may be light alignment layers having directivity formed by beams such as ultraviolet rays. The first alignment layer 11 and the second alignment layer 21 may also be alignment layers that may be hardened to have directivity formed by heat.

Referring to FIG. 1B, while the liquid crystal layer 3 is injected between the substrates 100 and 200, the first substrate 100 and the second substrate 200 may be bent to have a predetermined curvature. As shown in FIG. 2, the display panel 300 including the first substrate 100 and the second substrate 200 facing each other and the liquid crystal layer 3 injected between the substrates 100 and 200 may be bent to have the same curvature as a bottom portion 110 by using a manufacturing apparatus including a jig 21 for fixing the bottom portion 110 and a display panel 300.

Referring to FIG. 1C, while the first substrate 100 and the second substrate 200 are bent to have a predetermined curvature, a voltage may be supplied to electrodes formed on the first substrate 100 and the second substrate 200 to generate an electric field to the liquid crystal layer. The liquid crystal molecules 310 of the liquid crystal layer may respond to the electric field and may be inclined in different directions with respect to a domain boundary (DB).

As shown in FIG. 1D, while a plurality of liquid crystal molecules 310 are inclined in different directions with respect to the domain boundary (DB), heat or light such as ultraviolet rays may be applied to the display panel 300 to harden the first alignment layer 11 and the second alignment layer 21, the liquid crystal molecules 310 may complete the first alignment layer 11 and the second alignment layer 21 having a pretilt angle, and the liquid crystal molecules 310 may be arranged in different directions with respect to the domain boundary (DB).

The first alignment layer 11 and the second alignment layer 21 may be formed to have a pretilt angle in parallel with a direction in which the liquid crystal molecules 310 are inclined, and the liquid crystal molecules 310 may initially be aligned so that the liquid crystal molecules 310 may have a pretilt in four different directions and may be arranged while no electric field is applied to the liquid crystal layer.

The first substrate 100 and the second substrate 200 may be bent to have a predetermined curvature, and the display device including the first alignment layer 11 and the second alignment layer 21 that may allow the liquid crystal molecules 310 to have a pretilt angle so that the liquid crystal molecules 310 may be arranged in different directions with respect to the domain boundary (DB) may be formed.

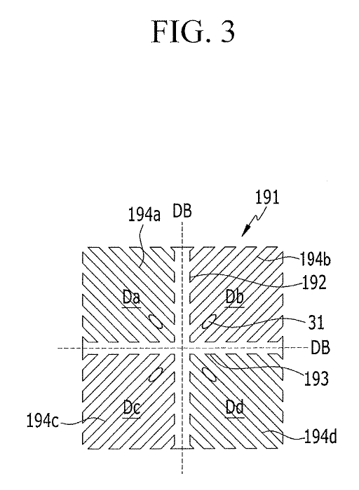

An example of a basic electrode 191 of a display device according to an exemplary embodiment and a corresponding domain will now be described with reference to FIG. 3. FIG. 3 illustrates a top plan view of a basic electrode of a display device according to an exemplary embodiment.

As shown in FIG. 3, an entire shape of a basic electrode 191 of a display device according to an exemplary embodiment may be quadrangular, and may include a cross-shaped stem including a horizontal stem 193 and a vertical stem 192 crossing the same. The basic electrode 191 may be divided into a first subregion (Da), a second subregion (Db), a third subregion (Dc), and a fourth subregion (Dd) by the horizontal stem 193 and the vertical stem 192, and the respective subregions (Da-Dd) may include a plurality of first to fourth fine branches 194a, 194b, 194c, and 194d.

The first fine branches 194a may be obliquely extended in a top left direction from the horizontal stem 193 or the vertical stem 192, and the second fine branches 194b may be obliquely extended in a top right direction from the horizontal stem 193 or the vertical stem 192. The third fine branches 194c may be extended in a bottom left direction from the horizontal stem 193 or the vertical stem 192, and the fourth fine branches 194d may be obliquely extended in a bottom right direction from the horizontal stem 193 or the vertical stem 192.

The first to fourth fine branches 194a, 194b, 194c, and 194d may form an angle of substantially 45 or 135 degrees with the gate lines 121a and 121b or the horizontal stem 193. The fine branches 194a, 194b, 194c, and 194d of two neighboring subregions of Da, Db, Dc, and Dd may be orthogonal to each other.

One basic electrode 191 may include the four subregions (Da-Dd) that may have different length directions of the fine branches 194a, 194b, 194c, and 194d, the liquid crystal molecules 31 may be inclined substantially in four directions, and four domains with different arranged directions of the liquid crystal molecules 31 may be formed on the liquid crystal layer 3 with respect to the domain boundary (DB) in parallel to the horizontal stem 193 or the vertical stem 192. The directions in which the liquid crystal molecules are inclined may be varied, and a reference viewing angle of the display device may be increased.

The first alignment layer 11 and the second alignment layer 21 may be formed to have a pretilt so that the liquid crystal molecules 310 may be inclined in different directions with respect to the domain boundary (DB), and the liquid crystal molecules 310 may be inclined in a predetermined direction in each domain.

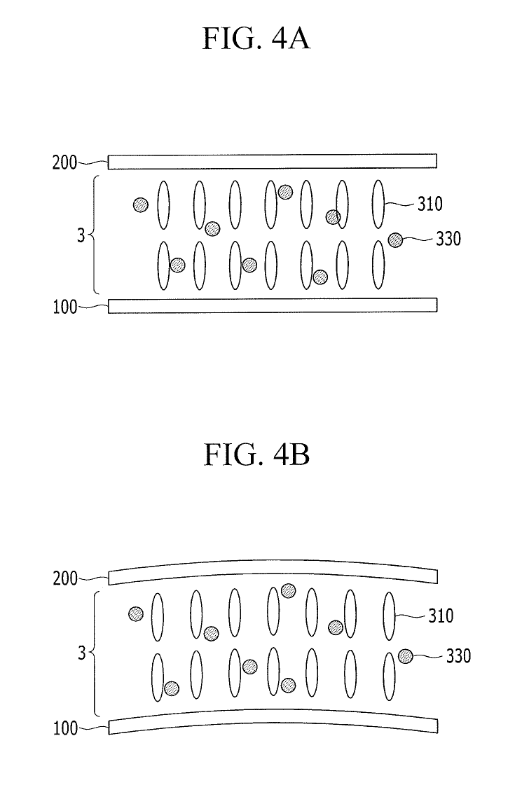

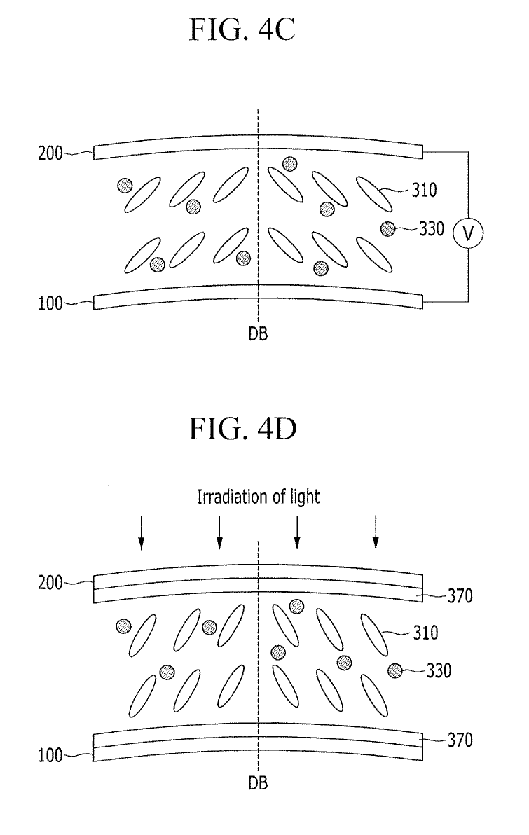

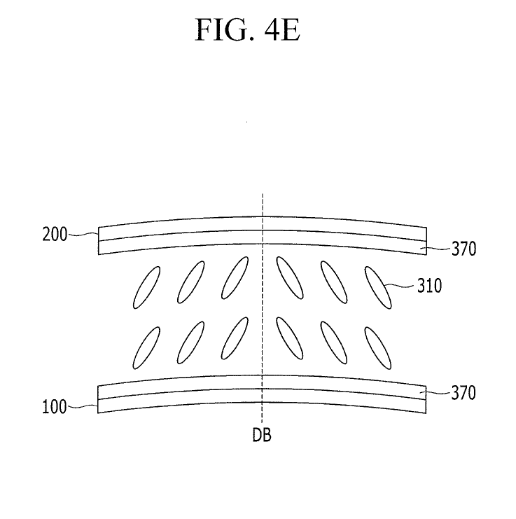

A method for manufacturing a display device according to an exemplary embodiment will now be described with reference to FIG. 4A to FIG. 4E. FIG. 4A to FIG. 4E illustrate a method for manufacturing a display device according to another exemplary embodiment.

Referring to FIG. 4A to FIG. 4E, a method for manufacturing a display device according to the present exemplary embodiment may be similar to the method for manufacturing a display device according to the exemplary embodiment described with reference to FIG. 1A to FIG. 1D.

Referring to FIG. 4A, the liquid crystal layer 3 including a prepolymer 330, e.g., one or more monomers hardened by polymerization caused by, for example, light beams (e.g., photopolymers), such as ultraviolet rays, and the liquid crystal molecules 310 may be injected between the first substrate 100 and the second substrate 200.

Referring to FIG. 4B, after the liquid crystal layer 3 including the liquid crystal molecules 310 and the prepolymer 330 is injected between the substrates 100 and 200, the first substrate 100 and the second substrate 200 may be bent to have a predetermined curvature. As shown in FIG. 2, the display panel 300 including the first substrate 100 and the second substrate 200 facing each other and the liquid crystal layer 3 injected between the substrates 100 and 200 may be bent to have a same curvature as the bottom portion 110 by using a manufacturing apparatus including the jig 21 for fixing the bottom portion 110 and the display panel 300.

Referring to FIG. 4C, while the first substrate 100 and the second substrate 200 are bent to have a predetermined curvature, a voltage may be supplied to electrodes formed on the first substrate 100 and the second substrate 200 to generate an electric field to the liquid crystal layer. The liquid crystal molecules 310 of the liquid crystal layer may respond to the electric field and may be inclined in a direction that is parallel to the length direction of the fine branches (194a-194d) through two stages as described with reference to FIG. 3, and the liquid crystal molecules 310 may be inclined in four directions on one pixel.

Referring to FIG. 4D, the liquid crystal molecules 310 may be arranged in different directions with respect to the domain boundary (D-band beams such as ultraviolet rays may be irradiated, and the prepolymer 330 may be polymerized to form a polymer 370 on a portion that is near the surfaces of the first substrate 100 and the second substrate 200 as shown in FIG. 4E.

While an electric field may be not applied to the liquid crystal layer, for example, because of the polymer 370, the liquid crystal molecules 310 may be initially aligned to have a pretilt in four different directions and may be arranged.

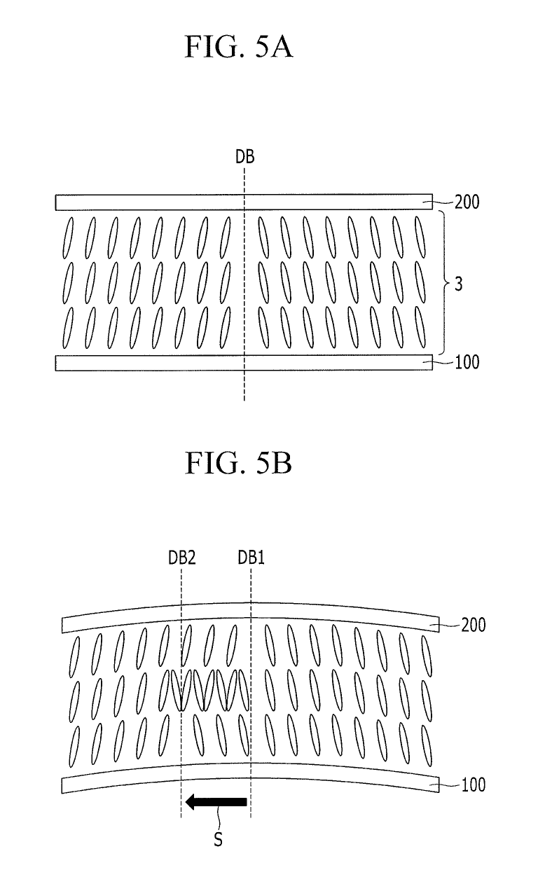

A display device manufactured by a comparative method for manufacturing a display device will now be described with reference to FIG. 5A and FIG. 5B. FIG. 5A and FIG. 5B illustrate a comparative display device and a manufacturing method thereof.

According to the comparative method for manufacturing a display device, as shown in FIG. 5A, the liquid crystal layer 3 may be injected between the first substrate 100 and the second substrate 200 facing each other, and an alignment layer may be formed so that the liquid crystal molecules may be arranged in different directions with respect to the domain boundary (DB). As shown in FIG. 5B, the display panel 300 including an alignment layer formed to be arranged in a different direction with respect to the domain boundary (DB) may be bent to have a predetermined curvature, and a curved display device may be completed. When the display device formed to arrange the liquid crystal molecules in different directions with respect to the boundaries of a plurality of domains is formed, the display device is bent to have a predetermined curvature to complete a curved display device, and the boundary of the domain is changed from the first boundary DB1 to the second boundary DB2. Therefore, the pretilt direction in which the liquid crystal molecules 310 are inclined may become irregular between the first boundary DB1 and the second boundary DB2, the direction in which the liquid crystal molecules 310 are inclined may become irregular, and display quality may be deteriorated.

According to the display device according to an exemplary embodiment and a manufacturing method thereof, the display device may be bent to have a predetermined curvature, light or heat may be applied thereto, the alignment layer may be formed to have pretilt angles in different directions on the domain boundaries of a plurality of domains, change of direction in which the liquid crystal molecules are inclined on the domain boundary of a curved display device may be prevented, and deterioration of the display quality that may occur near the domain boundary may be prevented.

According to the display device and the manufacturing method thereof according to an exemplary embodiment, in the case of a curved display device, the alignment layer may be formed so that the alignment layer may have pretilt angles in different directions on the domain boundaries of a plurality of domains, and change of direction in which the liquid crystal molecules are inclined on the domain boundary of the curved display device may be prevented. Should the curved state be reversed to a flat state, the position of the domain boundary may be changed, the direction in which the liquid crystal molecules are inclined may become irregular near the domain boundary, and deterioration of display quality may occur.

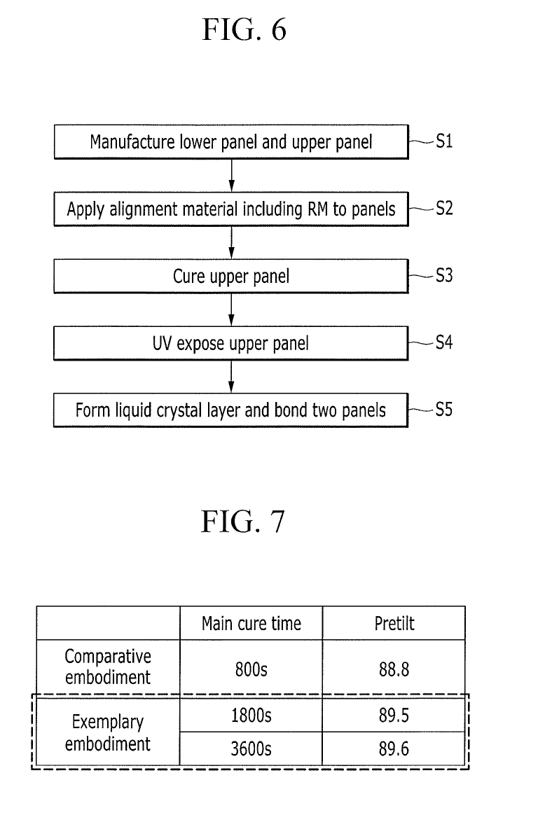

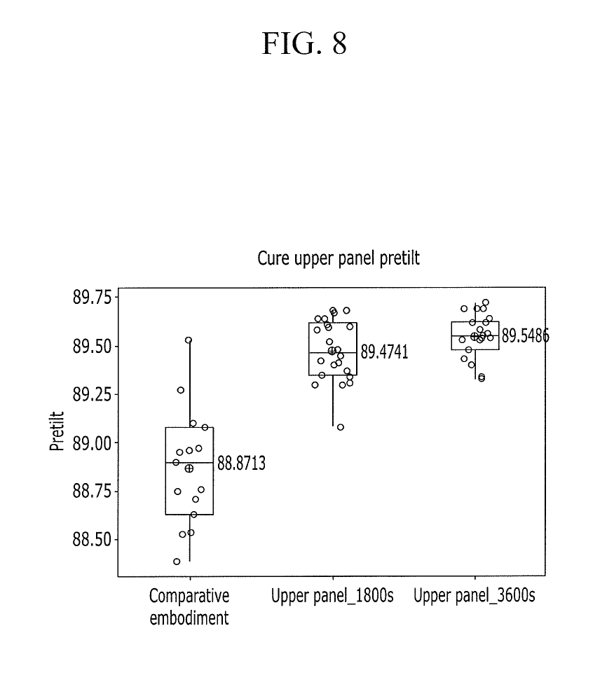

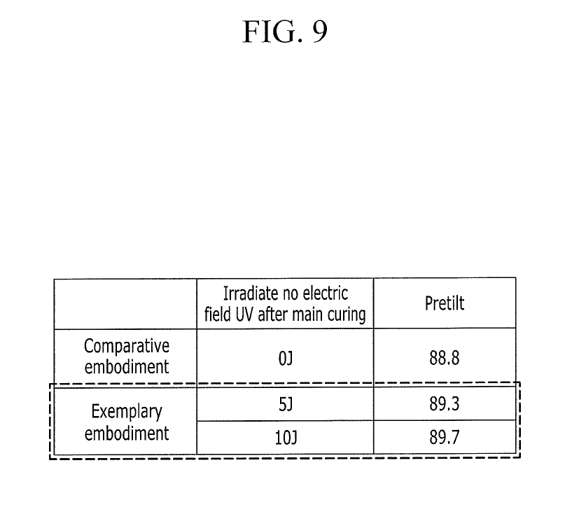

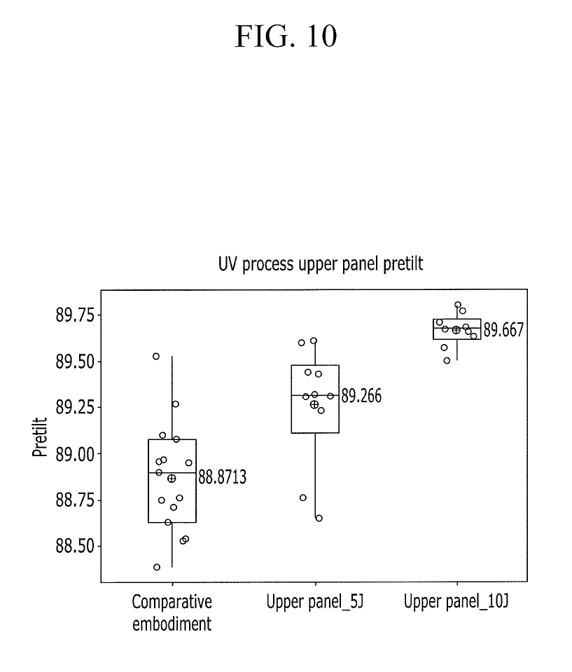

A method for, and results of, manufacturing a display device according to a second exemplary embodiment will be described with reference to FIG. 6 to FIG. 10. FIG. 6 illustrates a flowchart of a method for manufacturing a display device according to a second exemplary embodiment, FIG. 7 and FIG. 8 illustrate results of a comparative embodiment and a second exemplary embodiment for forming a pretilt angle on an upper panel by a heat treatment, and FIG. 9 and FIG. 10 illustrate results of a comparative embodiment and a second exemplary embodiment for forming a pretilt angle on an upper panel by irradiating ultraviolet rays.

A method for forming different pretilt angles of liquid crystal molecules provided near a first substrate and liquid crystal molecules provided near a second substrate will be described with reference to FIG. 6 to FIG. 10.

Referring to FIG. 6, forming of a display panel includes manufacturing a lower panel and an upper panel (S1).

Manufacturing a lower panel signifies, e.g., may include, manufacturing a thin film transistor panel excluding a lower alignment layer. For example, the lower panel may be manufactured by forming a gate conductor, a data conductor, a thin film transistor, a color filter, and a pixel electrode on a first substrate. Manufacturing an upper panel signifies, e.g., may include, manufacturing a second substrate excluding an upper alignment layer as an opposing substrate of the thin film transistor panel and a common electrode. For example, the upper panel may be manufactured by forming a light blocking member and a common electrode on an insulation substrate. Depending on exemplary embodiments, the light blocking member may be formed on the lower panel or on the upper panel and the lower panel.

An alignment material including a reactive mesogen (RM) is applied to the above-manufactured lower panel and the upper panel (S2). Applying the alignment material may be performed by a method such as inkjet printing or roll printing. An identical alignment material may be applied to the lower panel and the upper panel.

The alignment layer may include an alignment control layer 11a and a pretilt control layer provided on the alignment control layer 11a.

The alignment control layer 11a may be a polymer including a vertical alignment material. The alignment control layer 11a may be a polymer including a dianhydride-based monomer such as an alicyclic dianhydride-based monomer, a diamine-based monomer such as an aromatic diamine-based monomer or an aliphatic ring substituted aromatic diamine-based monomer, and an aromatic epoxide-based monomer, for example, a crosslinker. The alignment control layer 11a may include a polymer-based material such as one or more of polyimide, polyamic acid, polysiloxane, nylon, polyvinyl alcohol (PVA), or poly(vinyl chloride) (PVC).

The pretilt control layer may be a polymer that is a compound generated by a chemical bond of monomers including a vertical alignment material and a reactive mesogen (RM). The polymer configuring the pretilt control layer may include a dianhydride-based monomer such as an alicyclic dianhydride-based monomer, and a diamine-based monomer such as a photoreactive diamine-based monomer, an alkylated aromatic diamine-based monomer, or an aromatic diamine-based monomer.

The photoreactive diamine-based monomer of the polymer may include a reactive mesogen and may determine a pretilt direction of the pretilt control layer of the lower alignment layer. The polymer of the alignment control layer and the polymer including the reactive mesogen of the pretilt control layer may be bonded to each other in a chemical manner.

The reactive mesogen represents, e.g., may include, a material that may be cured by beams such as ultraviolet rays and may allow the pretilt in one direction. An example of the reactive mesogen may be a compound expressed by the following formula.

P1-A1-(Z1-A2)ₙ-P2

P1 and P2 are independently an acrylate, a methacrylate, a vinyl, a vinyloxy, or an epoxy; A1 and A2 are independently 1,4-phenylene or naphthalene-2,6-diyl; Z1 is COO—, OCO—, or a single bond; and n is 0, 1, and 2.

The upper panel is cured (S3). Curing the alignment material may include pre-curing at a low temperature and main-curing at a high temperature.

The pre-curing applies heat at, for example, about 70 to 100° C., by which a solvent of the alignment material may be vaporized and the compound in the alignment material may be phase-separated. The phase separation may be generated by a difference of polarities of components in the alignment material, and a material with a relatively great polarity may move around an electrode and a material with a relatively small polarity may move over the same.

The upper panel may be main-cured after the pre-curing.

The main-curing applies heat at, for example, about 200 to 250° C. A material with a relatively great polarity, for example, a polymer layer for forming the alignment control layer, may be arranged at a lower portion, and a material with a relatively small polarity, for example, a polymer layer for forming the pretilt control layer, may be arranged at an upper portion. As described above, the polymer configuring the pretilt control layer may be a polymer that may be generated by bonding the monomer including a reactive mesogen and another monomer.

The pretilt angle of the alignment layer included in the upper panel may be equal to or greater than 89 degrees and equal to or less than 90 degrees by adjusting a main-curing time to be longer than 800 seconds.

Referring to FIG. 7 and FIG. 8, when the main-curing time for the upper panel is set to be greater than 800 seconds, the pretilt angle of a second alignment layer 21 may approach 90 degrees.

The ultraviolet (UV) rays are irradiated to the upper panel (S4).

By the irradiation of the ultraviolet rays, part or all of the reactive mesogen of the alignment layer formed on the upper panel may be cured by light while not being pretilted. Therefore, an amount of the reactive mesogen not cured by light that may be arranged in a same direction as the liquid crystal molecules and may form a pretilt at the time of exposure of ultraviolet (UV) electric field that is performed after the two panels are bonded may be reduced. The pretilt angle of the alignment layer included in the upper panel may be equal to or greater than 89 degrees and equal to or less than 90 degrees.

Referring to FIG. 9 and FIG. 10, when the ultraviolet rays are irradiated to the upper panel after the upper panel is main-cured, the pretilt angle of the alignment layer of the upper panel may be equal to or greater than 89 degrees and equal to or less than 90 degrees.

In an embodiment, the irradiation of ultraviolet rays may last for about 20 minutes to an hour with intensity of about 5 J/cm² to 10 J/cm².

A liquid crystal layer is formed and the two panels are bonded (S5). The liquid crystal layer may be formed after the two panels are bonded, and vice versa. In an embodiment, liquid crystal may be applied to one of the two panels by a method such as inkjet printing and then the other panel may be bonded. In an embodiment, the two panels may be bonded and the liquid crystal may then be injected through an injection hole between the two panels.

As described above, the display panel may be bent with a predetermined curvature and the bent display panel may then be exposed to the ultraviolet ray electric field. The liquid crystal molecules on a first substrate of the liquid crystal display may have a pretilt angle that is equal to or greater than 89 degrees and equal to or less than 90 degrees, and the liquid crystal molecules on a second substrate of the liquid crystal display may have a pretilt angle that is equal to or greater than 80 degrees and less than 89 degrees.

According to the display device and the manufacturing method thereof according to a second exemplary embodiment, the curved display device may form the alignment layer so that domain boundaries of a plurality of domains may have pretilt angles in different directions. Therefore, changes of the direction in which the liquid crystal molecules are inclined at the domain boundary of the curved display device may be prevented, and the liquid crystal molecules provided near the upper panel may have the pretilt angle that is equal to or greater than 89 degrees and equal to or less than 90 degrees to prevent the changes of the direction in which the liquid crystal molecules are inclined at the domain boundary when the curved state is transformed into the flat state, and deterioration of displaying quality may be reduced.

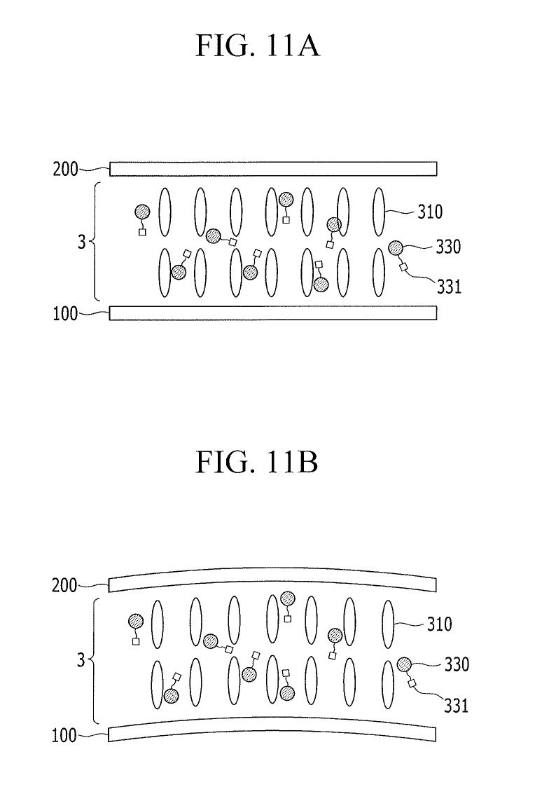

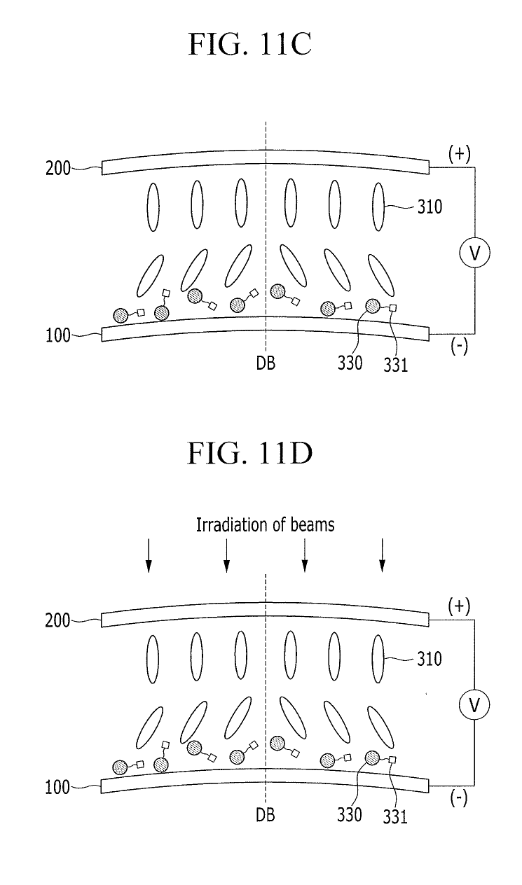

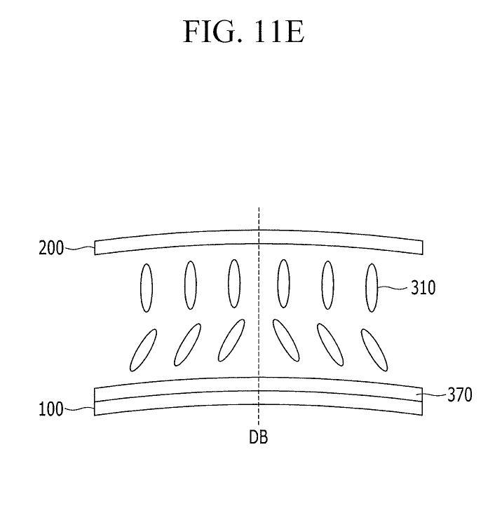

A method for manufacturing a display device according to a third exemplary embodiment will be described with reference to FIG. 11A to FIG. 11E. FIG. 11A through FIG. 11E illustrate a method for manufacturing a display device according to a third exemplary embodiment.

The method for manufacturing a display device according to the present exemplary embodiment with reference to FIG. 11A to FIG. 11E is similar to the method for manufacturing a display device according to an exemplary embodiment described with reference to FIG. 4A to FIG. 4E so no repeated description will be supplied.

Referring to FIG. 11A, a liquid crystal layer 3 including a prepolymer 330 such as a monomer cured by polymerization performed by beams such as ultraviolet rays and liquid crystal molecules 310 may be injected between the first substrate 100 and the second substrate 200 facing each other.

The prepolymer 330 may be combined with an ammonium-based material 331.

The ammonium-based material 331 may include tetramethylammonium hydroxide (TMAH) expressed in Equation 1, tetramethylammonium chloride (TMAC) expressed in Equation 2, or alkylammonium. For example, the alkylammonium may be alkylammonium expressed in Equation 3, dialkylammonium expressed in Equation 4, trialkylammonium expressed in Equation 5, or tetraalkylammonium expressed in Equation 6.

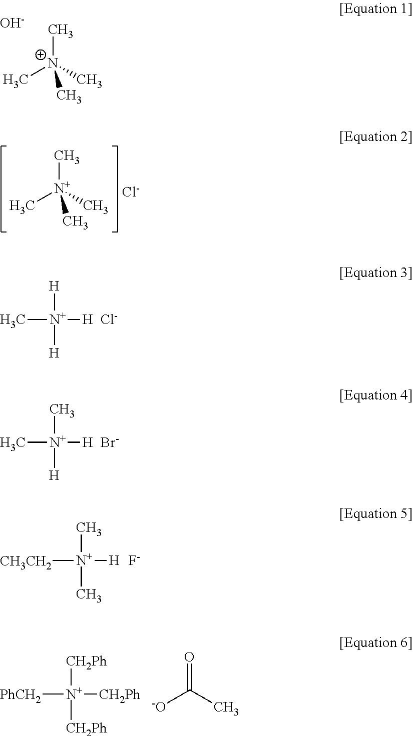

The prepolymer 330 and the ammonium-based material 331 may be bonded to have a positive (+) polarity.

Referring to FIG. 11B, the first substrate 100 and the second substrate 200 may be bent with a predetermined curvature while the liquid crystal layer 3 including the liquid crystal molecules 310 and the prepolymer 330 may be injected between the substrates 100 and 200.

Referring to FIG. 11C, a voltage may be applied to electrodes formed on the first substrate 100 and the second substrate 200 to generate an electric field to the liquid crystal layer 3 while the first substrate 100 and the second substrate 200 may be bent with a predetermined curvature.

A combined body of the prepolymer 330 and the ammonium-based material 331 may lean in one direction by an external electric field and may move. For example, the prepolymer 330 and the ammonium-based material 331 may have a positive (+) polarity and may move to the first substrate 100 having a negative (−) polarity.

The liquid crystal molecules 310 provided near the first substrate 100 may have a pretilt angle that is equal to or greater than 80 degrees and less than 89 degrees by the prepolymer 330 and the electric field, and the liquid crystal molecules 310 provided near the second substrate 200 may have a pretilt angle that is equal to or greater than 89 degrees and equal to or less than 90 degrees.

Referring to FIG. 11D, when beams such as ultraviolet rays are irradiated while an electric field is generated, e.g., applied, to the liquid crystal layer 3 to arrange the liquid crystal molecules 310 in different directions with reference to a domain boundary (DB), the prepolymer 330 may perform polymerization to form a polymer 370 near a surface of the first substrate 100 as shown in FIG. 11E. While no electric field is applied to the liquid crystal layer 3 by the polymer 370, the liquid crystal molecules 310 provided near the surface of the first substrate 100 may initially be aligned to be arranged with a pretilt that is equal to or greater than 89 degrees and equal to or less than 90 degrees.

According to the display device and the manufacturing method thereof according to a third exemplary embodiment, the curved display device may form the alignment layer so that the domain boundaries of a plurality of domains may have pretilt angles in different directions to prevent the change of the direction in which the liquid crystal molecules are inclined at the domain boundary of the curved display device, and the liquid crystal molecules provided near the second substrate 200 may have a pretilt that is equal to or greater than 89 degrees and equal to or less than 90 degrees to prevent the change of the direction in which the liquid crystal molecules are inclined at the domain boundary when the curved state is transformed into the flat state, and deterioration of displaying quality may be reduced.

By way of summation and review, vertical alignment of a liquid crystal display in which a long axis of liquid crystal molecules is perpendicular to a surface of a substrate may be developed with a mode for realizing a light viewing angle. Various methods for initially aligning liquid crystal molecules so that the liquid crystal molecules may have a pretilt may increase a response speed of the liquid crystal display. For example, a method that may allow liquid crystal molecules to have a pretilt by using prepolymers polymerized by beams such as ultraviolet rays may apply a desired voltage to field generating electrodes which may then be exposed to light.

Liquid crystal displays may become wider, and curved display devices may be developed to enhance immersion and realism of viewers.

When a curved display device is formed, the liquid crystal molecules may be exposed to light so that they may have a pretilt and the display device may be formed to be curved. Pretilt directions of the liquid crystal molecules may become irregular depending on positions of the curved display device, and display quality may be deteriorated.

Provided is a display device that may prevent deterioration of display quality by preventing a pretilt direction of liquid crystal molecules from becoming irregular through exposure in a curved display device including liquid crystal molecules having a pretilt angle, and a manufacturing method thereof.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A method for manufacturing a display device, comprising:
providing a first substrate and a second substrate;
forming a display panel, forming the display panel including injecting a liquid crystal layer including liquid crystal molecules between the first substrate and the second substrate;
bending the display panel to a predetermined curvature to form a bent display panel; and
forming an alignment layer so that directions in which the liquid crystal molecules are arranged in the liquid crystal layer of the bent display panel include a plurality of different domains.

2. The method as claimed in claim 1, wherein forming the alignment layer includes:
applying an electric field to the liquid crystal layer after bending the display panel; and
irradiating beams or applying heat to the display panel.

3. The method as claimed in claim 2, wherein the liquid crystal molecules of the liquid crystal layer are substantially perpendicular to surfaces of the first substrate and the second substrate prior to bending the display panel.

4. The method as claimed in claim 3, wherein pretilt angles of the liquid crystal molecules near the first substrate and the liquid crystal molecules near the second substrate are different from each other.

5. The method as claimed in claim 4, wherein the pretilt angle of the liquid crystal molecules near the first substrate is equal to or greater than 80 degrees and less than 89 degrees, and the pretilt angle of the liquid crystal molecules near the second substrate is equal to or greater than 89 degrees and equal to or less than 90 degrees.

6. The method as claimed in claim 5, wherein forming the display panel includes:
manufacturing a lower panel and an upper panel;
applying a same alignment material including a reactive mesogen to the lower panel and the upper panel;
curing the upper panel;
exposing ultraviolet rays to the upper panel; and
forming a liquid crystal layer and bonding the two panels.

7. The method as claimed in claim 6, wherein curing the upper panel includes:
pre-curing the upper panel; and
main-curing the upper panel,
wherein the main-curing is performed for longer than 30 minutes.

8. The method as claimed in claim 6, wherein:
the ultraviolet rays have an intensity of about 5 J/cm² to 10 J/cm²; and
exposing the ultraviolet rays to the upper panel includes exposing the ultraviolet rays for about 20 minutes to an hour.

9. The method as claimed in claim 1, wherein forming the display panel includes injecting the liquid crystal molecules and prepolymers polymerized by light between the first substrate and the second substrate.

10. The method as claimed in claim 9, wherein forming the alignment layer includes:
applying an electric field to the liquid crystal layer after bending the display panel; and
irradiating light to the display panel.

11. The method as claimed in claim 10, wherein the liquid crystal molecules of the liquid crystal layer are substantially perpendicular to surfaces of the first substrate and the second substrate prior to bending the display panel.

12. The method as claimed in claim 1, wherein each of the plurality of different domains includes liquid crystal molecules arranged in a single direction.

13. The method as claimed in claim 7, wherein adjacent domains have a domain boundary therebetween, the direction of arrangement of the liquid crystal molecules changing at the domain boundary.

14. The method as claimed in claim 11, wherein pretilt angles of the liquid crystal molecules near the first substrate and the liquid crystal molecules near the second substrate are different from each other.

15. The method as claimed in claim 14, wherein the pretilt angle of the liquid crystal molecules near the first substrate is equal to or greater than 80 degrees and less than 89 degrees, and the pretilt angle of the liquid crystal molecules near the second substrate is equal to or greater than 89 degrees and equal to or less than 90 degrees.

16. The method as claimed in claim 15, wherein the liquid crystal layer includes a prepolymer cured by polymerization caused by ultraviolet rays and an ammonium-based material combined with the prepolymer, and the prepolymer and the ammonium-based material have a positive (+) polarity.

17. The method as claimed in claim 16, wherein applying the electric field to the liquid crystal layer includes moving the prepolymer and the ammonium-based material to the lower panel by the electric field.

18. A display device, comprising:
a first substrate and a second substrate facing each other;
a liquid crystal layer between the first substrate and the second substrate and including liquid crystal molecules; and
an alignment layer on surfaces of the first substrate and the second substrate,
the display device being bent to a predetermined curvature and including a plurality of domains in which arranged directions of the liquid crystal molecules of the liquid crystal layer are different.

19. The display device as claimed in claim 18, wherein at least one of the alignment layer and the liquid crystal layer includes photopolymers.

20. The display device as claimed in claim 19, wherein the liquid crystal molecules of the liquid crystal layer are substantially perpendicular to surfaces of the first substrate and the second substrate prior to the display device being bent.

21. The display device as claimed in claim 18, wherein the liquid crystal molecules of the liquid crystal layer are substantially perpendicular to surfaces of the first substrate and the second substrate prior to the display device being bent.

22. The display device as claimed in claim 21, wherein pretilt angles of the liquid crystal molecules near the first substrate and the liquid crystal molecules near the second substrate are different from each other.

23. The display device as claimed in claim 22, wherein the pretilt angle of the liquid crystal molecules near the first substrate is equal to or greater than 80 degrees and less than 89 degrees, and the pretilt angle of the liquid crystal molecules near the second substrate is equal to or greater than 89 degrees and equal to or less than 90 degrees.

24. The display device as claimed in claim 18, wherein each of the plurality of domains includes liquid crystal molecules arranged in a single direction.

25. The display device as claimed in claim 24, wherein adjacent domains have a domain boundary therebetween, the direction of arrangement of the liquid crystal molecules changing at the domain boundary.
